(19) United States
(12) Patent Application Publication
(10) Pub. No.: US 2025/0335829 A1
(43) Pub. Date: Oct. 30, 2025

(54) MACHINE-LEARNING MODELS FOR DYNAMIC CORRECTIVE ACTIONS

(71) Applicant: Maplebear Inc., San Francisco, CA (US)

(72) Inventors: Qing Miao, Atlanta, GA (US); Richard Lam, Long Island City, NY (US); Robert Border, Atlanta, GA (US); Vagisha Ahlawat, Austin, TX (US); Rishab Prashanth, Toronto (CA)

(21) Appl. No.: 18/645,241

(22) Filed: Apr. 24, 2024

(51) Int. Cl. G06N 20/20

(52) U.S. Cl. CPC G06N 20/20

(57) ABSTRACT

A system collects user data describing characteristics of multiple users. A first machine-learning model assesses this data to predict churn scores of the users. When a user sends an error signal concerning their experience with the system, the system retrieves a identified churn score for this user and applies a second machine-learning model. This second model takes as input user data and their churn score to select a corrective action among a set of corrective actions aimed at reducing the user's churn score. After implementing the selected corrective action, the system collects and updates the user's data to reflect their continued engagement or departure. The system uses this updated user data to retrain the first or second model to improve the predictive accuracy of the first or second model.

### BACKGROUND

Modern online systems are complex computer engineering systems that require many engineers to maintain. This engineering complexity can lead to system errors where the online system experiences some error in a workflow. For example, these errors may include (but are not limited to) technical issues with the mobile application and website, servers being down for maintenance or fixes, or data ingestion issues with third-party systems. Elevated error rates in the online system can lead to user dissatisfaction and decrease user interaction rates. For example, when users encounter a technical error, their immediate experience with the mobile application and website may be disrupted. This disruption can range from minor inconvenience to complete inability to use the product as intended. Repeated issues can erode trust in the online service's reliability. Further, with an uptick in errors, there is often a corresponding increase in user support requests. If the support system is overwhelmed or unable to resolve issues promptly, users' dissatisfaction grows, contributing further to the likelihood of churn.

### SUMMARY

Embodiments described herein relate to a method or system for managing user engagement within an online system. The system accesses user data that describes characteristics of a plurality of users of an online system and applies a first machine-learning model on the user data to determine a churn score of each user. The churn score of each user indicates a likelihood of the corresponding user discontinuing use of the online system for a period of time. In one or more embodiments, the first machine-learning model is an offline model that is applied to each of the plurality of users offline.

The system receives an alert about a system error or an error signal from a client device of a user among the plurality of users. The error signal is related to experience of the user with the online system. Responsive to receiving the error signal, the system applies a second machine-learning model on data describing the error signal, the churn score of the user, and the error signal from the user to select one or more corrective actions from a set of corrective actions that are applicable to users. The second machine-learned model is trained to access a set of corrective actions that are applicable to users. Notably, an actual reduction of churn score of each corrective action of the set of corrective actions to the online system is uncertain if the corrective action were to be applied to the user. The system generates an error correction score for each corrective action in the set of corrective actions based on the data describing the error signal and the churn score of the user. The error correction score indicates a reduction of the churn score of the user after the application of the corrective action to the user. The system selects one or more corrective actions from the set of corrective actions based on the generated error correction scores, and applies the selected one or more corrective actions to the user, causing a client device of the user to display the selected one or more corrective actions. The system also collects user data describing user engagement or disengagement with the online system following the application of the selected one or more corrective actions, and retrains the first or second machine-learning model based on the updated user data.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example environment in which an error correction module is configured to recommend error correction responsive to an error signal from a user in accordance with one or more embodiments.

FIG. 4 illustrates data flow through an example error correction recommendation model, in accordance with one or more embodiments.

FIG. 5 is a flowchart illustrating an example method for selecting a corrective action in accordance with one or more embodiments.

### DETAILED DESCRIPTION

Retaining users is key to driving growth in online systems. These systems often experience user churn and lack proactive measures to reduce user departure, especially during direct interactions with support staff. Addressing this issue, a machine learning approach is used to identify users who could benefit from targeted corrective actions while they are in contact with support staff, enhancing the chance of retaining users at interaction points.

Conventionally, online concierge systems often apply corrective actions only upon direct requests from users, typically in response to issues related to orders, such as missing items or delivery failures. The anticipation from such a policy is generally a refund corresponding to the value of the missing or problematic item. However, this approach fails to address the broader impact of the service failure. For instance, if a user's Thanksgiving order lacks a turkey while all other complimentary items are delivered, simply refunding the cost of the turkey does not compensate for the disruption of the entire Thanksgiving dinner. Similarly, refunding an order for medication that failed to be delivered due to a technical issue with the online system does not solve the underlying health needs of the user. In these scenarios, without further error correction, users are likely to seek alternatives, potentially abandoning the online system altogether. Additionally, there is an opportunity to engage new users or those contacting support for guidance on using a mobile app or website. Offering timely incentive error corrections during such interactions could effectively recover user satisfaction after negative experiences or encourage further orders. This strategy supplements existing error correction policies without negating any current measures.

Embodiments described herein solve the above-described problem by training and applying two different machine learning models. A first model (also referred to as a “churn prediction model”) operates offline and is applied to all active users, trained to predict user churn score using the latest available user data or features, which are stored in the online system's database. A second model (also referred to as an “error correction recommendation model”) operates in real-time or near real time, using the output from the first model to recommend corrective actions. When a user deemed at risk of churning reaches out to the support center, the support team can input details into the real-time model to identify the best approach for retaining the user. For instance, a user phoning in about order problems might be offered additional error corrections, whereas a user looking to cancel an order might respond better to a free delivery coupon offer. Ultimately, the recommendation varies, providing personalized error correction based on the unique reasons users have for contacting support.

The training data or input for the first model may include (but are not limited to) (1) an overall ordering frequency, and its recent change, (2) an overall ordering gross merchandise value (GMV), item count, and its recent change, (3) an overall order issues such as missing item, damaged item, fail to deliver, and (4) an overall order item quality such as fill rate, replacement rate, refund rate, and its recent change, (5) an overall order delivery quality such as early or late delivers, and its recent change, (6) an overall chat or phone contacts to support centers, including sentiment from the contact and whether the issue was addressed via contact, and/or (7) any other bad experiences that the user experienced recently such as a technical issue.

The output of the first model may be churn score, i.e., a probability of a user churning. In one or more embodiments, a threshold churn score is set. If a user's churn score is greater than the threshold, the user is considered a churning user. Responsive to determining that the user is a churning user, the user is passed to the second model.

The first model may be a logistic regression model or a gradient boosting model, e.g., eXtreme Gradient Boosting (XGB) model. It can be trained offline at a certain interval such as every 24 hours. The logistic regression model is trained to estimate probabilities using a logistic function that takes input features for any given user and maps it between 0 and 1, indicating a probability that the given user is likely to churn.

The gradient boosting model is an ensemble learning method, which builds a strong predictive model by combining predictions from multiple simpler models. In one or more embodiments, gradient boosting builds a model by sequentially adding decision trees, where each subsequent tree corrects errors made by previous ones. Gradient boosting begins with a base model that makes simple predictions. After that, sequential learning is performed. At each step, a new decision tree is added. instead of trying to predict the target variable directly, this tree predicts the residual error made by the previous tree in the sequence. Gradient descent algorithm is then used to minimize a loss function (a measure of how far off predictions are from actual outcomes). Each new tree is added to the ensemble with a scaling factor known as a learning rate, which helps to control the contribution of each tree, preventing the model from fitting too closely to the training data (overfitting). Techniques such as subsampling and penalizing complex models can be applied to improve model performance and robustness.

The training data or input of the second model may include (but are not limited to) all inputs to the first model described above, output from the first model, user income attributes such as zip code, average income, house value, available corrective actions, such as coupons, marketing campaigns at the time of contact, and/or information related to the user's error signal. In one or more embodiments, a support agent is asked to input information related to the user's error signal, e.g., reasons the user contacts the support center, such as issues related to an order, issues related to the mobile app or website, etc.

The output of the second model includes one or more best corrective actions to retain users. The corrective actions may include (but are not limited to) issuing a credit, offering a free membership, offering a marketing coupon, conducting customer training, and/or helping the user to solve a problem without financial incentive.

The second model may be a reinforcement learning model, such as a multi-armed bandit contextual learning model. The reinforcement learning model trains an agent to make decisions by taking actions in an environment to achieve a goal. The agent learns from the outcomes of its actions rather than from being told explicitly what to do. This learning process is driven by the feedback received in the form of rewards or penalties, which are given based on the actions the agent takes. The objective of reinforcement learning is to learn a strategy of choosing actions given states of the environment that maximize a cumulative reward over time. In a multi-armed bandit contextual learning model, each arm represents an action that can be taken, and an agent tries to decide which action to take, how many times to take each action, and in what order to maximize their return.

The second model is trained to evaluate and optimize outcomes in real-time. Once a user uses the online system or places an order after the corrective action is applied, a feedback loop is triggered to update the second model.

### Example Embodiment of Online Concierge System

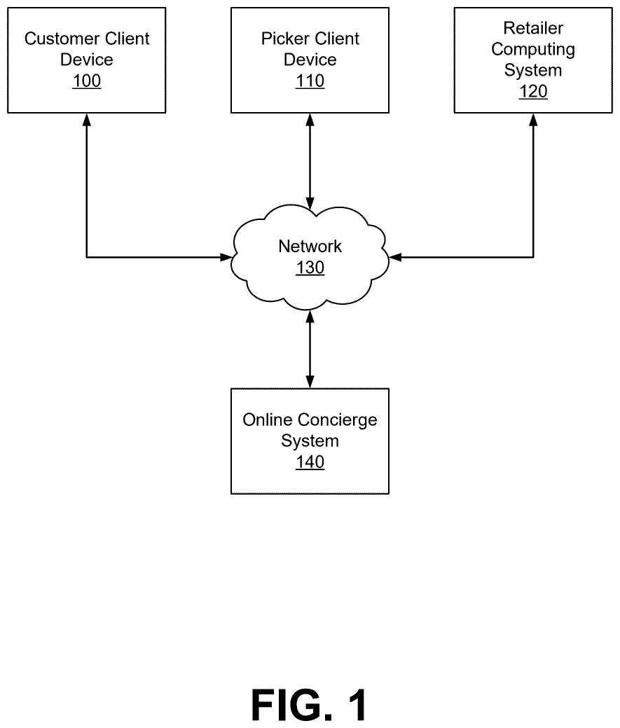

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In one or more embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item”, as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In one or more embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In one or more embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In one or more embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In one or more embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In one or more embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In one or more embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in one or more embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In one or more embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user. The online concierge system 140 may charge a user for the order and provide portions of the payment from the user to the picker and the retailer.

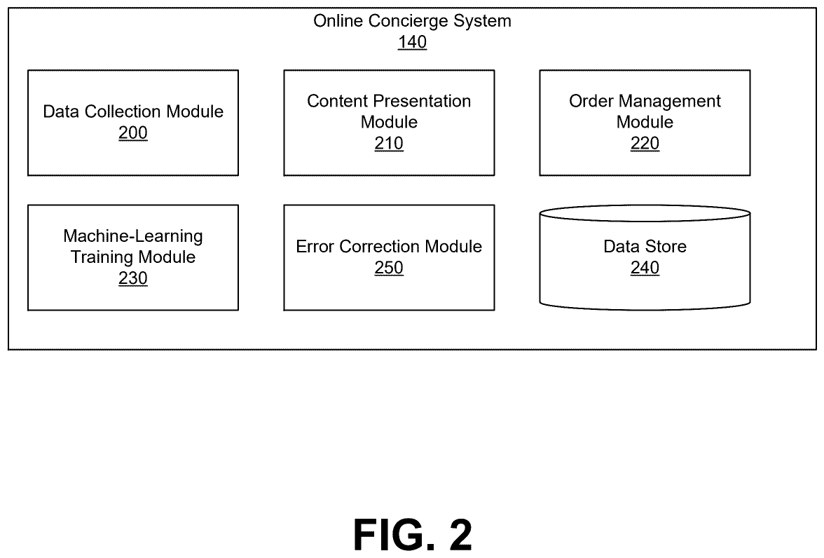

As an example, the online concierge system 140 may allow a user to order groceries from a grocery store retailer. The user's order may specify which groceries they want delivered from the grocery store and the quantities of each of the groceries. The user's client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with one or more embodiments. The system architecture illustrated in FIG. 2 includes a data collection module 200, a content presentation module 210, an order management module 220, a machine-learning training module 230, an error correction module 250, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave the delivery of the order. In one or more embodiments, the order data includes user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In one or more embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In one or more embodiments, the item selection model uses item embeddings describing items and user embeddings describing users to score items. These item embeddings and user embeddings may be generated by separate machine-learning models and may be stored in the data store 240.

In one or more embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In one or more embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In one or more embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In one or more embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In one or more embodiments, the order management module 220 computes an estimated time of arrival of the picker at the delivery location and provides the estimated time of arrival to the user.

In one or more embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In one or more embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

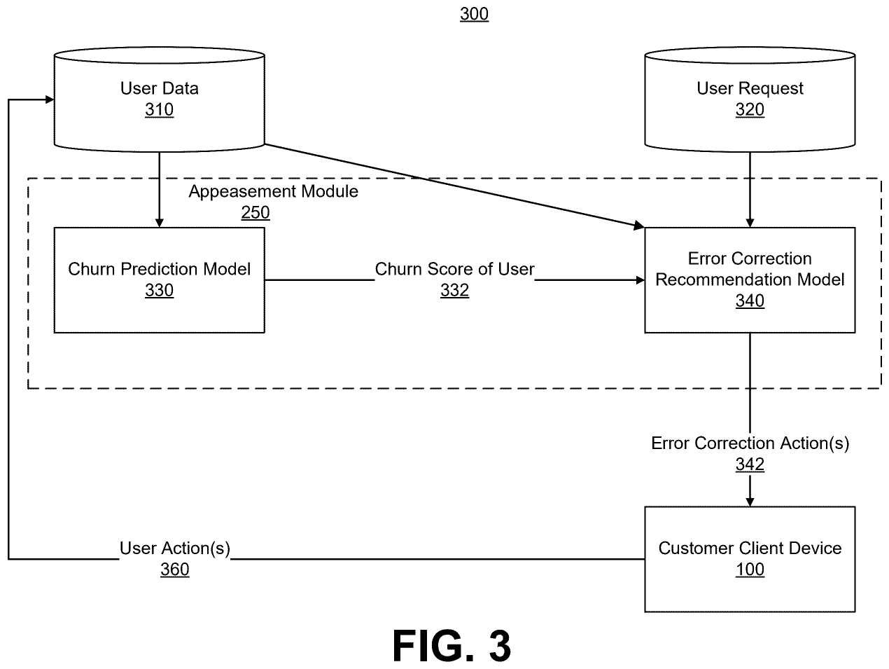

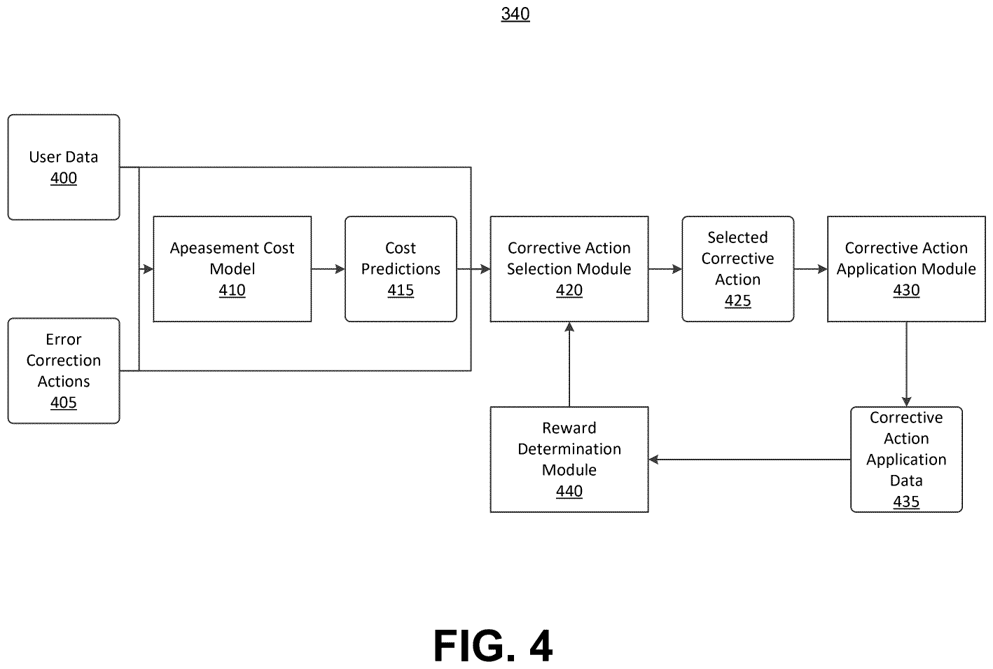

The error correction module 250 manages requests received from users and determines a corrective action to apply to each request. A corrective action is an action the online concierge system 140 applies to a user to remedy an issue that occurred with the user's order or user's interaction with the online concierge system 140. Further details of the method of recommending corrective actions are discussed with respect to FIGS. 3-4.

### Example Error Correction Module

FIG. 3 illustrates an example environment 300 in which an error correction module 250 is configured to recommend error correction responsive to a user error signal in accordance with one or more embodiments. The error correction module 250 applies two machine learning models, namely churn prediction model 330 and an error correction recommendation model 340. The churn prediction model 330 is configured to take user data 310 about a user as input to determine a churn score 332 of the user. The churn score indicates a probability that the user will churn (i.e., stop using the online concierge system 140).

Responsive to receiving a user error signal, the error correction recommendation model 340 takes the user data 310 about the user, the churn score 332 of the user determined by the churn prediction model 330, and real time data related to a user error signal 320 as input to recommend one or more corrective actions 342 that are to be applied to the user. The user error signal may be received via a phone call to a support center, a message to a chatbot, an email, among others. The error correction recommendation model 340 is able to recommend corrective actions in near real time and cause the recommended corrective actions 342 to be applied to a user account of the user. Once the corrective actions 324 are applied to the user account, customer client device 100 of the user receives the corrective actions 324. The corrective actions may include (but are not limited to) a refund of an item in an order, a refund of an order, a cancellation of an order, a coupon for an item, a coupon for a free delivery, a coupon for a free membership for a period, etc. Once the user receives the corrective action 324 via the customer client device 100, the user may perform one or more actions 360, such as interact with the received coupon, make an order using the coupon, or the like. The user actions 360 are then recorded as part of the user data 310. The updated user data 310 may then be used to retrain the churn prediction model 350 and/or the error correction recommendation model 340. Additional details about the error correction recommendation model 340 are further described below with respect to FIG. 4.

### Example Error Correction Recommendation Model

FIG. 4 illustrates data flow through an example error correction recommendation model 340, in accordance with one or more embodiments. Alternative embodiments may include more, fewer, or different components from those illustrated in FIG. 4 and the functionality of each component may be divided between the components differently from the description herein.

Additionally, the functionality of each component may be performed automatically without human instruction or intervention. Furthermore, the error correction recommendation model illustrated in FIG. 4 may include some or all of the functionality or structure of the error correction recommendation model 250 illustrated in FIG. 2. Additionally or alternatively, the error correction recommendation model illustrated in FIG. 4 may be stored on and/or executed on one or more computing devices, such as online concierge system 102.

The error correction recommendation model receives user data 400 describing characteristics of a user. A user may be a customer, a picker, or a runner. The user data 400 may describe a user's interactions with the online concierge system, such as when the user has interacted with the online concierge system, what kinds of interactions the user has with the online concierge system, how often the user interacts with the online concierge system, or characteristics of the user's interactions with the online concierge system. Additionally, the user data 400 may describe demographic or personal information about the user, such as the user's name, age, gender, sex, income, contact information, location, or residence. In one or more embodiments, the error correction recommendation model receives user data 400 from a customer database 214, a picker database 212, an inventory database 204, or a transaction records database 208 of the online concierge system.

The error correction recommendation model also receives a set of corrective actions 405 that it may apply to a user. A corrective action 405 is an action that the online concierge system may take with regards to a user to encourage the user to interact with the online concierge system. For example, for a customer user, a corrective action 405 may include notifying the user of a new product, sending a message to the user encouraging the user to submit an order, sending a coupon to the user, offering the user a temporary or permanent discount on orders, offering the user a free product, or offering to reduce or eliminate fees on a user's purchase. For a picker user or a runner user, a corrective action 405 may include notifying the user of a possible order for servicing, offering the user an additional service fee for servicing an order from another user, offering a temporary or permanent increase in a service fee or commission paid to the user for servicing orders, or offering a reward to the user for servicing a certain number of orders within a time period. A corrective action 405 may further include an encouraged interaction for the user to perform. An encouraged interaction is an interaction that is targeted by the online concierge system for the user to perform. For example, an encouraged interaction may be for a user to place an order with the online concierge system or to service an order for the online concierge system.

Each corrective action 405 may be associated with error correction data describing the corrective action. The error correction data may describe corrective action parameters for the application of the corrective action. For example, corrective action parameters for a corrective action 405 may include timeframes when a corrective action should be applied, characteristics of users to whom the corrective action 405 should be applied, a value of consideration to provide to a user or a percentage for a discount to apply to a user's order. The error correction data may also include a corrective action type for each corrective action 405. For example, the corrective action type may indicate whether the corrective action 405 includes a discount, a coupon, a notification, or consideration to provide to the user. In one or more embodiments, the set of corrective actions 405 includes multiple corrective actions 405 with the same corrective action type but different corrective action parameters. For example, the set of corrective actions 405 may include multiple discount offers, where each discount offer has a different discount percentage.

Each corrective action 405 may be associated with a cost to the online concierge system for applying the corrective action 405 to a user. For example, a corrective action cost may include consideration that the online concierge system provides to a user to encourage the user to interact with the online concierge system (e.g., a discount on a product to a customer or an additional service to a picker or runner). A corrective action cost also may include an opportunity cost for the online concierge system representing the lost reward to the online concierge system by applying one corrective action to a user rather than a different corrective action 405. Furthermore, a corrective action cost may be based on a limited number of times the online concierge system may apply a particular corrective action 405 to any user or a limited number of times that the online concierge system may apply a corrective action 405 to a particular user. For example, the online concierge system may limit the number of notifications that it provides to a user to avoid over-loading the user with too many notifications. Similarly, the online concierge system may limit the number of discounts or increased service fees that applies to users based on constraints provided by third parties to the online concierge system. Additionally, a corrective action cost may be based on computer resources that are used to apply a corrective action 405. For example, a corrective action cost may be based on processing resources, networking resources, or memory resources used by the application of a corrective action 405.

The cost of applying a corrective action 405 to a user may not be certain at the time that the corrective action is applied to the user. In one or more embodiments, the online concierge system may be uncertain as to whether a corrective action cost will be incurred at all by applying a corrective action 405 to a user. For example, the online concierge system may provide the benefit of a corrective action 405 to user on the condition that the user perform the encouraged interaction with the online concierge system. Thus, the online concierge system may be uncertain at the time of applying the corrective action 405 to the user whether the user will perform the encouraged interaction, and therefore may be uncertain whether the online concierge system will incur a corrective action cost. For example, the online concierge system may offer an increased service fee to a picker user only if the picker user services a particular number of orders for customer users within a time period. The online concierge system may be uncertain whether the user will perform the required number of orders within the time period, and thus may be uncertain whether it will incur the cost of providing the user with the increased service fee.

Similarly, the online concierge system may be uncertain as to the magnitude of a corrective action cost at the time of applying the corrective action 405. For example, the online concierge system may offer an increased commission percentage to a picker user if the picker user services an order within a time period. The online concierge may be uncertain as to the size of an order to be assigned to the picker user, and thus may be uncertain as to the size of the commission that the online concierge system will provide to the user if the user services an order within the time period.

The error correction recommendation model applies a corrective action cost model 410 to the user data 400 and the corrective actions 405 to generate corrective action cost predictions 415 for the corrective actions 405. The corrective action cost model 410 utilizes machine learning techniques, such as neural networks, to predict the costs associated with implementing corrective actions for users. It processes user data 400 and information about potential corrective actions 405 to estimate these costs. A corrective action cost prediction 415 reflects an anticipated impact of applying a specific corrective action to a user, potentially representing the total expected cost to the system managing these actions. This prediction can factor in various cost considerations, such as the lowest or highest possible costs, the average cost for a particular action type, or the probability of incurring any cost at all.

The corrective action cost model 410 may be trained based on a set of training examples of corrective actions applied to users and labels representing the actual costs of corrective actions. For example, a training example might include user data from an individual who interacted with the online concierge system 140 and received a specific corrective action, along with details about the corrective action taken. The training process for the corrective action cost model 410 includes using these examples to predict the actual cost associated with each corrective action, based on the user and action details provided. The model's cost predictions are then measured against the real costs, as denoted by the training example labels, to evaluate accuracy.

To refine its predictions, the corrective action cost model 410 undergoes updates that reconcile the differences between predicted costs and actual costs. This refinement is guided by a loss function, which assesses the model's performance by quantifying the discrepancy between predicted and actual costs. Adjustments to the model 410 may be made through a process known as back-propagation, which iteratively improves the model 410's accuracy. In some embodiments, the corrective action cost model 410 includes a machine-learned model for each type of corrective action. These specialized models are each trained to predict the costs associated with their respective corrective actions, enhancing the overall precision of cost predictions.

The corrective action selection module 420 selects a corrective action to apply to the user. To select a corrective action, the corrective action selection module 420 generates a corrective action score for each corrective action. A corrective action score is a score that reflects an expected reward to the online concierge system if the associated corrective action is applied to the user. To encourage the exploration of less-selected corrective actions, the corrective action selection module 420 may use a probability distribution (e.g., a normal distribution or a beta distribution) associated with each corrective action to generate a corrective action score for each corrective action. The corrective action selection module 420 may adjust the corrective action scores based on the user data 400 describing the user to reflect how each corrective action may be more effective for certain users over other users. Additionally, the corrective action selection module 420 may adjust the corrective action scores based on the corrective action cost predictions 415 associated with each corrective action such that the corrective action scores reflect their likely respective costs to the online concierge system for application to the user. The corrective action selection module 420 may select which corrective action to apply to the user based on the corrective action scores for each corrective action 405. In one or more embodiments, the corrective action selection module 420 uses a multi-arm bandit algorithm to select the corrective action to apply to the user. For example, the corrective action selection module 420 may use Thompson sampling to select a corrective action.

The corrective action selection module 420 may use corrective action selection parameters associated with each corrective action to select a corrective action. Corrective action selection parameters are parameters that the corrective action selection module 420 uses for the generation of the corrective action scores for the corrective actions 405. For example, corrective action selection parameters for a corrective action may include parameters for a probability distribution that is used to generate the corrective action score. The corrective action selection parameters also may include adjustments that may be made to the generated corrective action scores to encourage the selection of corrective actions with more certain rewards or to encourage the selection of corrective actions with less certain, but potentially higher rewards. For example, to increase the likelihood that a corrective action is selected, the corrective action selection module 420 may increase a weight applied to the corrective action score for the corrective action.

In one or more embodiments, the corrective action selection parameters include weights that are used by a machine learning model (e.g., a neural network) that is trained to generate corrective actions scores for corrective actions based on user data 400 for a user and corrective action cost predictions for the corrective actions. For example, the error correction recommendation model may access a set of training examples. Each training example may include user data 400 for a user who was treated and corrective action cost predictions for corrective actions to apply to the user. Each training example may further include a label indicating a ground-truth corrective action score for each corrective action. The error correction recommendation model may apply a backpropagation process to update weights used by a machine-learning model to generate a final set of weights for the machine-learning model to use when being applied to user data 400 and corrective action cost predictions.

The corrective action selection module 420 may update the corrective action selection parameters based on a reward to the online concierge system for applying the selected corrective action 425 to the user. For example, if the corrective action selection module 420 uses the corrective action selection parameters as parameters for probability distributions for the scoring of corrective actions, the corrective action selection module 420 may treat the reward as a sample of the probability distribution associated with the selected corrective action 425 and may update the corrective action selection parameters for the probability distribution based on the value of the reward. In one or more embodiments, the corrective action selection module 420 updates the corrective action selection parameters based on a reward determined by the reward determination module 440.

The corrective action application module 430 applies the selected corrective action 425 to the user. The corrective action application module 430 may apply the selected corrective action 425 to the user by transmitting instructions to a user device associated with the user to display a message associated with the corrective action. For example, the corrective action application module 430 may transmit instructions to a picker device associated with a picker user instructing the picker device to display and offer an increased service fee to the picker user if the picker user services at least a threshold number of orders within a certain time period.

The corrective action application module 430 also may collect corrective action application data 435 describing characteristics of the application of the corrective action to the user. For example, the corrective action application data 435 may describe the user's interactions with the online concierge system after the selected corrective action 425 is applied to the user. For example, if the corrective action applied to a customer gives the customer user a discount on an order, the corrective action application data 435 may describe whether the user placed an order with the online concierge system using the provided discount and how the customer user's order compares with an ordinary order placed by the customer user. The corrective action application module 430 also may collect corrective action application data 435 describing a size of the user's order, the number of orders placed or serviced by the user, how long after the application of the corrective action to the user performed the intended interaction, and whether the user continued interacting with the online concierge system after performing an encouraged interaction.

The reward determination module 440 determines a reward to the online concierge system of the application of the selected corrective action 425 to the user. The corrective action reward determined by the reward determination module 430 may be a gross value received by the online concierge system based on the selected corrective action 425. For example, the online concierge system may determine a gross amount of consideration that the online concierge system received based on the user performing an encouraged interaction associated with the selected corrective action 425. In one or more embodiments, the reward determination module 440 determines net reward received by the online concierge system in response to applying the corrective action to the user. For example, the reward determination module 440 may determine a net change in the user's behavior after the corrective action, and may determine the reward to the online concierge system based on the net change in the user's behavior. In one or more embodiments, the reward determined by the reward determination module is an uplift in the user's interaction with the online concierge system. The reward determination module 440 may provide the determined reward to the corrective action selection module 420 to update corrective action selection parameters for the selection of corrective actions.

By improving the process by which an online concierge system selects a corrective action to apply to a user, the error correction recommendation model may expedite how long it takes the online concierge system to collect sufficient training data for different corrective actions. Thus, the error correction recommendation model may reduce the overall computational resources required to generate an effective system by which the online concierge system selects corrective actions for users.

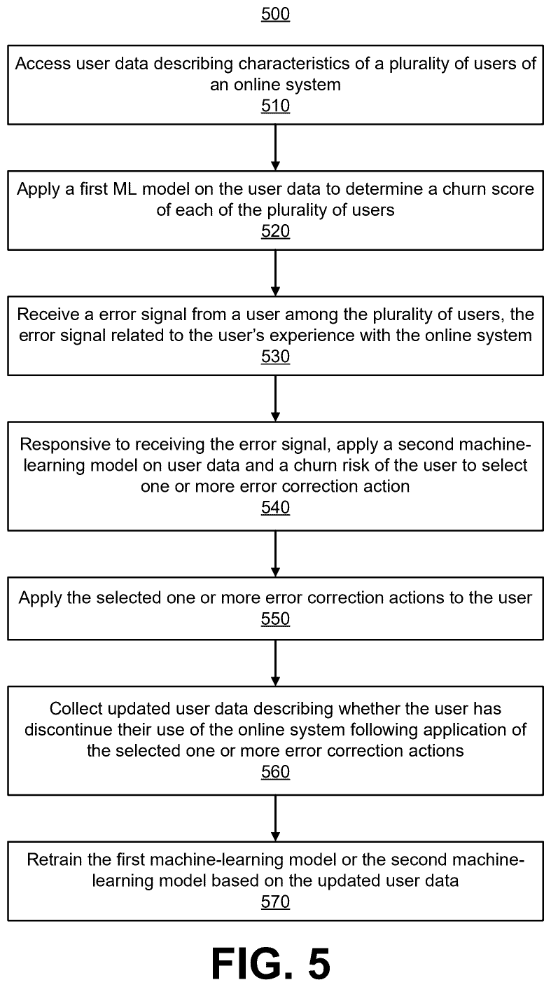

FIG. 5 is a flowchart illustrating an example method for selecting a corrective action, in accordance with one or more embodiments. Alternative embodiments may include more, fewer, or different steps from those illustrated in FIG. 5 and may perform the steps in a different order from that illustrated in FIG. 5. The method illustrated by FIG. 5 may be performed by an online system, such as the online concierge system 140, or an error correction module of an online concierge system, such as the error correction module 250 illustrated in FIG. 2.

The online system accesses 510 user data describing characteristics of a plurality of users at an online system.

The online system applies 520 a first machine-learning model on the user data to determine a churn score of each of the plurality of users. The churn score of each of the plurality of users indicates a probability that a corresponding user will discontinue their use of the online system within a time period. In one or more embodiments, the application of the first machine-learning model is performed offline. The churn score of each user is stored relationally to the user data describing characteristics of the corresponding user.

The online system receives 530 an error signal from a user among the plurality of users. The error signal is related to the user's experience with the online system. For example, the error signal may be related to an issue related to a particular order (e.g., delayed delivery, failure to deliver, unnotified delivery attempt), a particular item of the particular order (e.g., damaged item, incorrect item, missing item), an issue related to a mobile application or website, among others.

Responsive to receiving the error signal, the online system applies 540 a second machine-learning model on user data, a churn score of the user, and the error signal from the user to select one or more corrective actions from a set of corrective actions that are applicable to users. The second machine-learning model is trained to access the set of corrective actions that are applicable to users. The actual impact of each corrective action in the set of corrective actions on reducing a churn score of the user is uncertain when the corrective action was to be applied to the user. The online system generates an error correction score for each corrective action in the set of corrective actions based on the user data describing the characteristics of the user, the churn score of the user, and the error signal from the user. The error correction score indicates a reduction of churn score of the user after applying the corrective action to the user.

The online system applies 550 the selected one or more corrective actions to the user. In one or more embodiments, the online system sends the selected one or more corrective actions to a client device associated with the user, causing the one or more corrective actions to be displayed on a graphical user interface of an application installed on the client device. The one or more corrective actions may include (but are not limited to) issuing a credit, offering a free membership, offering a marketing coupon, conducting customer training, and/or helping the user to solve a problem without financial incentive. Upon receiving one or more corrective actions, the user may engage or disengage with the online system, such as redeeming a credit, using a coupon to make an order, or stopping using the online system.

The online system collects 560 updated user data describing user engagement or disengagement with the online system following the application of the selected one or more corrective actions. Based on the updated user data, the online system retrains 570 the first and/or second machine-learning models to improve their predictive accuracy.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In one or more embodiments, a software module is implemented with a computer program product comprising one or more computer-readable media storing computer program code or instructions, which can be executed by a computer processor for performing any or all of the steps, operations, or processes described. In one or more embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
at a computer system comprising a processor and a computer-readable medium:
accessing user data describing characteristics of a plurality of users of an online system;
applying a first machine-learning model on the user data to identify a churn score of each of the plurality of users, the churn score of each user indicating a probability that a corresponding user will discontinue their use of the online system within a time period;
receiving an error signal from a client device of a user among the plurality of users, the error signal indicating a system error that occurred at the online system;
responsive to receiving the error signal,
applying a second machine-learning model on user data describing characteristics of the user, the churn score of the user, and the error signal from the user to select one or more corrective actions from a set of corrective actions that are applicable to users, wherein the second machine-learning model is trained to:
access the set of corrective actions that are applicable to users, wherein an actual impact of each corrective action in the set of corrective actions on reducing a churn score of the user is uncertain when the corrective action were to be applied to the user;
generate an error correction score for each corrective action in the set of corrective actions based on the user data describing the characteristics of the user, the churn score of the user, and the error signal from the user, wherein the error correction score indicates a reduction of churn score of the user after applying the corrective action to the user;
select a corrective action from the set of corrective actions based on the generated error correction scores;
applying the selected one or more corrective actions to the user;
collecting updated user data describing user engagement or disengagement with the online system following the applying the selected one or more corrective actions; and
retraining the first machine-learning model or the second machine-learning model based on the updated user data.

2. The method of claim 1, wherein the method further comprises sending the selected one or more corrective actions to a client device of the user, causing the client device of the user to display the selected one or more corrective actions.

3. The method of claim 1, the first model comprises a logistic regression model or an extreme gradient boosting (XGB) model.

4. The method of claim 1, wherein the method further comprises:
identifying whether the churn score of the user is greater than a threshold, and
responsive to identifying that the churn score is greater than the threshold,
applying the second machine-learning model on user data describing
characteristics of the user and the churn score of the user.

5. The method of claim 1, wherein the set of corrective actions comprise coupons available at current time.

6. The method of claim 1, wherein the second machine-learning model is a reinforcement learning model.

7. The method of claim 1, wherein the second machine-learning model is a multi-armed bandit contextual learning model, and wherein the multi-armed bandit contextual learning model is trained to predict a likelihood of user interaction with the online system in response to taking a corrective action.

8. The method of claim 1, wherein the second machine-learning model is trained to identify one or more corrective actions, how many times each of the one or more corrective actions is to be applied, and an order in which the one or more corrective actions are to be applied.

9. A non-transitory computer-readable storage medium having instructions encoded thereon that, when executed by one or more processors, cause the one or more processors to perform actions comprising:
accessing user data describing characteristics of a plurality of users of an online system;
applying a first machine-learning model on the user data to identify a churn score of each of the plurality of users, the churn score of each user indicating a probability that a corresponding user will discontinue their use of the online system within a time period;
receiving an error signal from a client device of a user among the plurality of users, the error signal related to experience of the user with the online system;
responsive to receiving the error signal,
applying a second machine-learning model on user data describing characteristics of the user, the churn score of the user, and the error signal from the user to select one or more corrective actions from a set of corrective actions that are applicable to users, wherein the second machine-learning model is trained to:
access the set of corrective actions that are applicable to users, wherein an actual impact of each corrective action in the set of corrective actions on reducing a churn score of the user is uncertain when the corrective action were to be applied to the user;
generate an error correction score for each corrective action in the set of corrective actions based on the user data describing the characteristics of the user, the churn score of the user, and the error signal from the user, wherein the error correction score indicates a reduction of churn score of the user after applying the corrective action to the user;
select a corrective action from the set of corrective actions based on the generated error correction scores;
applying the selected one or more corrective actions to the user;
collecting updated user data describing user engagement or disengagement with the online system following the applying the selected one or more corrective actions; and
retraining the first machine-learning model or the second machine-learning model based on the updated user data.

10. The non-transitory computer-readable storage medium of claim 9, the instructions further cause the one or more processor to send the one or more corrective actions to a client device of a user, the client device of the user to display the selected one or more corrective actions.

11. The non-transitory computer-readable storage medium of claim 9, wherein the first model comprises a logistic regression model or an extreme gradient boosting (XGB) model.

12. The non-transitory computer-readable storage medium of claim 9, wherein the one or more processors are further caused to:
identify whether the churn score of the user is greater than a threshold, and
responsive to identifying that the churn score is greater than the threshold, apply the second machine-learning model on user data describing characteristics of the user and the churn score of the user.

13. The non-transitory computer-readable storage medium of claim 9, wherein the set of corrective actions comprise coupons available at current time.

14. The non-transitory computer-readable storage medium of claim 9, wherein the second machine-learning model is a reinforcement learning model.

15. The non-transitory computer-readable storage medium of claim 9, wherein the second machine-learning model is a multi-armed bandit contextual learning model, and wherein the multi-armed bandit contextual learning model is trained to predict a likelihood of user interaction with the online system in response to taking a corrective action.

16. The non-transitory computer-readable storage medium of claim 9, wherein the second machine-learning model is trained to identify one or more corrective actions, how many times each of the one or more corrective actions is to be applied, and an order in which the one or more corrective actions are to be applied.

17. A computing system, comprising one or more processors; and
a non-transitory computer-readable storage medium having instructions encoded thereon that, when executed by the one or more processors, cause the one or more processors to perform actions comprising:
accessing user data describing characteristics of a plurality of users of an online system;
applying a first machine-learning model on the user data to identify a churn score of each of the plurality of users, the churn score of each user indicating a probability that a corresponding user will discontinue their use of the online system within a time period;
receiving an error signal from a client device of a user among the plurality of users, the error signal related to experience of the user with the online system;
responsive to receiving the error signal,
applying a second machine-learning model on user data describing characteristics of the user, the churn score of the user, and the error signal from the user to select one or more corrective actions from a set of corrective actions that are applicable to users, wherein the second machine-learning model is trained to:
access the set of corrective actions that are applicable to users, wherein an actual impact of each corrective action in the set of corrective actions on reducing a churn score of the user is uncertain when the corrective action were to be applied to the user;
generate an error correction score for each corrective action in the set of corrective actions based on the user data describing the characteristics of the user, the churn score of the user, and the error signal from the user, wherein the error correction score indicates a reduction of churn score of the user after applying the corrective action to the user;
select a corrective action from the set of corrective actions based on the generated error correction scores;
applying the selected one or more corrective actions to the user;
collecting updated user data describing user engagement or disengagement with the online system following the applying the selected one or more corrective actions; and
retraining the first machine-learning model or the second machine-learning model based on the updated user data.

18. The computing system of claim 17, the instructions further cause the one or more processor to send the one or more corrective actions to a client device of a user, the client device of the user to display the selected one or more corrective actions.

19. The computing system of claim 17, wherein the first model comprises a logistic regression model or an extreme gradient boosting (XGB) model.

20. The computing system of claim 17, wherein the one or more processors are further caused to:
identify whether the churn score of the user is greater than a threshold, and
responsive to identifying that the churn score is greater than the threshold, apply the second machine-learning model on user data describing characteristics of the user and the churn score of the user.
